(19) United States
(12) Patent Application Publication
(10) Pub. No.: US 2023/0165214 A1
(43) Pub. Date: Jun. 1, 2023

(54) PET SAFETY BAG FOR VEHICLE

(71) Applicant: Hongbin Zheng, Shenzhen (CN)

(72) Inventor: Hongbin Zheng, Shenzhen (CN)

(21) Appl. No.: 17/537,586

(22) Filed: Nov. 30, 2021

(51) Int. Cl. A01K 1/02

(52) U.S. Cl. CPC A01K 1/0272

(57) ABSTRACT

A pet safety bag for a vehicle includes an extendable enclosure and a supporting frame structure. The extendable enclosure includes an inner space defined by a bottom wall and side walls extending upwardly from the bottom wall along its edges to define bottom joint edge, and terminating at a top edge, wherein side walls are joined along respective edges thereof to define side joint edges. Further, the supporting frame structure may be hingedably coupled along the top edge, side joint edges, and the bottom joint edges to provide support to the extendable enclosure and prevent deformation when a pet lay along the top edge of the extendable enclosure.

### FIELD OF THE DISCLOSURE

The present disclosure relates to carrying bags, and, more particularly, to a pet safety bag for a vehicle.

### BACKGROUND OF THE DISCLOSURE

Pets have been best companion to their owners, and thus, pet owners may have a strong desire to spend as much time as possible with their pet throughout a given day, and, even sometime while travelling in their vehicles. However, travelling with one's pet may have inherent safety concerns and potential logistical difficulties which may arise during the course of such outing. For instance, when the pet is in the vehicle, the owner may let the pet sit across a car window. Allowing the pet see out the car window from the passenger seat or a rear-seat in a safe manner is a benefit to the pet owners. There are known pet-containers for small dogs and other pets in cars, but none with the convenience of use, pet safety, pet comfort and pet positioning by a window. For example, while the pet is seeing through the car window from the pet-containers, the pet-containers may get deformed and the pet may be compromised from safety point of view.

Accordingly, there exists a need to overcome shortcomings of the conventional pet-containers. For example, there exists a need that may protect deformation of the such pet-containers so that the pet safety is uncompromised.

### SUMMARY OF THE DISCLOSURE

In view of the foregoing disadvantages inherent in the prior art, the general purpose of the present disclosure is to provide a pet safety bag for a vehicle, to include all advantages of the prior art, and to overcome the drawbacks inherent in the prior art.

An object of the present disclosure is to provide a pet safety bag that may have protection against deformation so that the pet safety is uncompromised.

An object of the present disclosure is to provide pet safety bag that has simple and easy to use deformation protection structure.

In light of the above objects, in one aspect of the present disclosure, a pet safety bag for carrying a pet in a vehicle is provided. The pet safety bag includes an extendable enclosure and at least one supporting frame structure. The extendable enclosure includes an inner space defined by a bottom wall and extendable side walls coupled to the bottom wall along its edges and adapted to be extended upwardly from the bottom wall to define bottom joint edge, and terminable at a top edge. The side walls are joined along respective edges thereof to define side joint edges. Further, the at least one supporting frame structure is hingedably coupled along at least a portion of the top edge. The at least one supporting frame structure, at an engaging position, is configured to be coupled alongside of the side joint edges, and the bottom joint edges to provide support to the extendable side walls to enable the extendable enclosure to be in an extended position. Further, the at least one side supporting frame structure, at a non-engaging position, is configured to be uncoupled from the side joint edges, and the bottom joint edges to collapse the extendable side walls to enable the extendable enclosure to be in a collapsed position.

In one embodiment of the present disclosure, the supporting frame structure 130 may include an upper frame member, side frame members and a bottom frame member joint together. The upper frame member is releasably or hingedly coupled along at least one top portion of the top edge. Further, the side frame members are releasably coupled along at least two side joint edges. Furthermore, the bottom frame member is releasably coupled along at least one bottom joint edge of the bottom joint edge.

In one embodiment of the present disclosure, the pet safety bag may further include a top releasably or hingedly coupling arrangement, side releasably coupling arrangements, and a bottom releasably coupling arrangement. The top releasably or hingedly coupling arrangement is coupled along the at least one top portion of the top edge to couple the upper frame member. Further, the side releasably coupling arrangements are coupled along the at least two side joint edges to couple the side frame members. Moreover, the bottom releasably coupling arrangement is coupled along the at least one bottom joint edge of the bottom joint edge to couple the bottom frame member.

In one embodiment of the present disclosure, the top releasably or hingedly coupling arrangement, the side releasably coupling arrangements, and the bottom releasably coupling arrangement are Velcro attachments.

In one embodiment of the present disclosure, the top releasably or hingedly coupling arrangement, the side releasably coupling arrangements, and the bottom releasably coupling arrangement are snap arrangements having brackets to releasably receive the upper frame member, the side frame members and the bottom frame member.

In one embodiment of the present disclosure, the top releasably or hingedly coupling arrangement is a narrow channel formed along the at least one top portion of the top edge to hingedly receive the upper frame member.

In one embodiment of the present disclosure, a shape of the supporting frame structure corresponds to a shape of the side walls of the extendable enclosure.

In one embodiment of the present disclosure, the supporting frame structure 130 is a one-piece structure made of metals or alloy or hard plastics.

In one embodiment of the present disclosure, the pet safety bag may include a securing arrangement coupled to the extendable enclosure, wherein the securing arrangements are adapted to be coupled to a vehicle seat for coupling the pet safety bag to the seat of the vehicle.

In one embodiment of the present disclosure, the pet safety bag may further include a pet leashing member coupled to the extendable enclosure. The pet leashing member may be adapted to leash the pet when the pet is in the extendable enclosure.

In one embodiment of the present disclosure, the pet safety bag may further include a carrying attachment having a pair of engaging members and a carrying strap. The pair of engaging members may be coupled to opposite side walls of the extendable enclosure. Further, the carrying strap may be removably coupled to the pair of engaging members to carry the pet safety bag.

In one embodiment of the present disclosure, the pet safety bag may further include a zipper arrangement coupled along an outer surface of the extendable enclosure. The zipper arrangement in an open state enables expansion of the sides of the extendable enclosure, and in a closed state stores the sides of the extendable enclosure.

In one embodiment of the present disclosure, the pet safety bag may further include a cushioning enclosure adapted to be disposed within the extendable enclosure to provide comfort to the pet adapted to be kept in the extendable enclosure. The cushioning enclosure generally complements a size of the extendable enclosure, and comprises one or more recesses.

In one further aspect of the present disclosure, a pet safety bag for carrying a pet in a vehicle is provided with a cushioning enclosure. The pet safety bag includes an extendable enclosure and at least one supporting frame structure. The extendable enclosure includes an inner space defined by a bottom wall and extendable side walls coupled to the bottom wall along its edges and adapted to be extended upwardly from the bottom wall to define bottom joint edge, and terminable at a top edge. The side walls are joined along respective edges thereof to define side joint edges. Further, the pet safety bag includes at least one supporting frame structure is hingedably coupled along at least a portion of the top edge. The at least one supporting frame structure, at an engaging position, is configured to be coupled alongside of the side joint edges, and the bottom joint edges to provide support to the extendable side walls to enable the extendable enclosure to be in an extended position. Further, the at least one side supporting frame structure, at a non-engaging position, is configured to be uncoupled from the side joint edges, and the bottom joint edges to collapse the extendable side walls to enable the extendable enclosure to be in a collapsed position. The pet safety bag further includes the cushioning enclosure adapted to be disposed within the extendable enclosure to provide comfort to the pet adapted to be kept in the extendable enclosure, wherein the cushioning enclosure complements a size of the extendable enclosure. The cushioning enclosure includes one or more recesses.

In one embodiment of the present disclosure, the pet safety bag may further include a pet leashing member coupled to the extendable enclosure. The pet leashing member adapted extend from one of the recesses of the cushioning enclosure to leash the pet when the pet is in the extendable enclosure.

In one embodiment of the present disclosure, the pet safety bag may further include a carrying attachment having a pair of engaging members and a carrying strap. The pair of engaging members may be coupled to opposite side wall of the extendable enclosure. Further, the carrying strap may be removably coupled to the pair of engaging members to carry the pet safety bag. The pair of engaging members may be adapted to extend from one of the other recesses of the cushioning enclosure to be removably coupled to the carrying strap.

This together with the other aspects of the present disclosure, along with the various features of novelty that characterize the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description taken in conjunction with the accompanying drawing, in which:

FIG. 1 illustrates an environment, whereby a pet safety bag is shown to be placed along seat of the vehicle for carrying a pet, in accordance with an exemplary embodiment of the present disclosure;

FIGS. 2A and 2B, respectively, illustrate a perspective and a side view of pet safety bag, in accordance with an exemplary embodiment of the present disclosure;

FIGS. 2C and 2D, respectively, illustrate top perspective views from various angles of the pet safety bag, in accordance with an exemplary embodiment of the present disclosure;

FIGS. 3A, 3B and 3C illustrate various coupling arrangements configured along a pet safety bag, in accordance with an exemplary embodiment of the present disclosure;

FIG. 4 illustrates a pet safety bag depicting one or more associated components thereof, in accordance with an exemplary embodiment of the present disclosure;

FIG. 5 illustrates the pet safety bag depicting various elements, such as a pet leashing member, a carrying attachment, and the like, in accordance with an exemplary embodiment of the present disclosure;

FIG. 6 illustrates the pet safety bag depicting a zipper arrangement, in accordance with an exemplary embodiment of the present disclosure;

FIGS. 7A and 7B illustrate a pet safety bag with a cushioning enclosure disposed within an extendable enclosure, in accordance with an exemplary embodiment of the present disclosure;

FIG. 8A depicts a perspective view of the pet safety bag coupled to the vehicle seat; and

FIG. 8B depicts a side view of the pet safety bag coupled to the vehicle seat.

Like reference numerals refer to like parts throughout the description of several views of the drawing.

### DETAILED DESCRIPTION OF THE DISCLOSURE

The exemplary embodiments described herein detail for illustrative purposes are subject to many variations in implementation. The present disclosure provides pet safety bag for a vehicle. It should be emphasized, however, that the present disclosure is not limited only to what is disclosed and extends to cover various alternation to the pet safety bag. It is understood that various omissions and substitutions of equivalents are contemplated as circumstances may suggest or render expedient, but these are intended to cover the application or implementation without departing from the spirit or scope of the present disclosure.

The terms “a” and “an” herein do not denote a limitation of quantity, but rather denote the presence of at least one of the referenced items.

The terms “having”, “comprising”, “including”, and variations thereof signify the presence of a component.

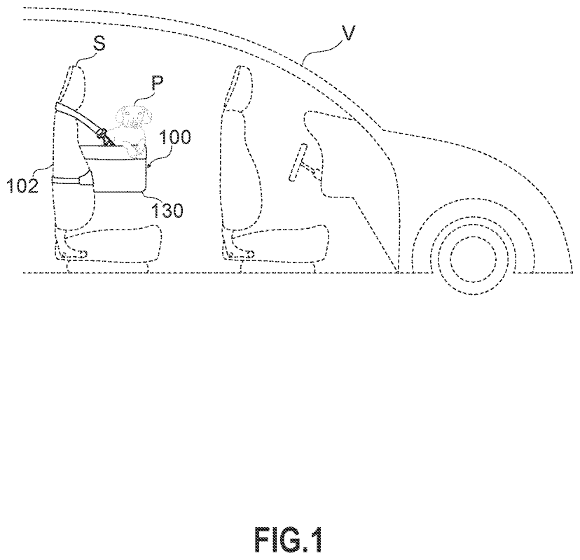

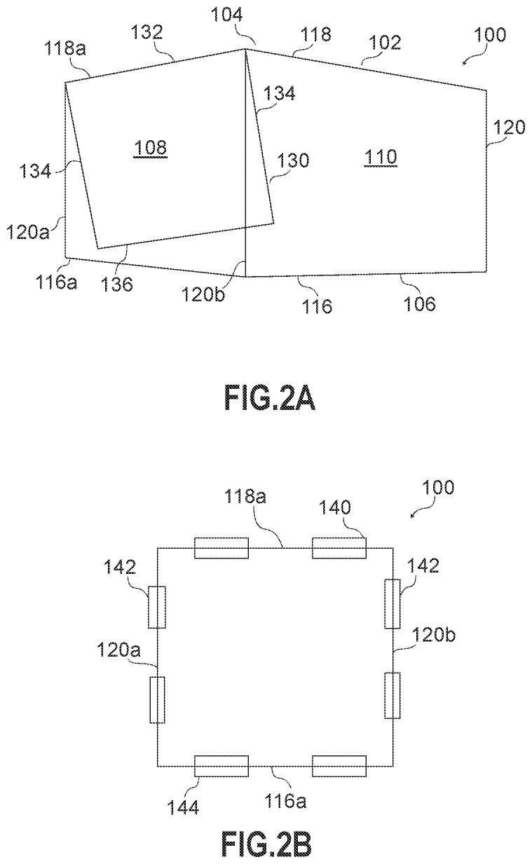

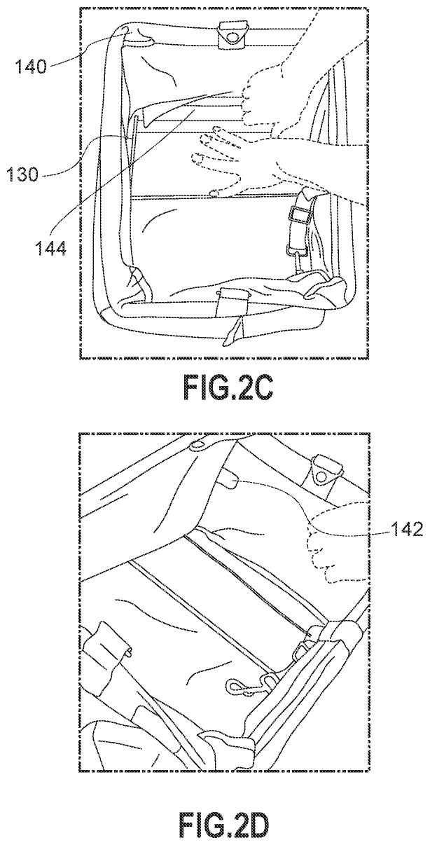

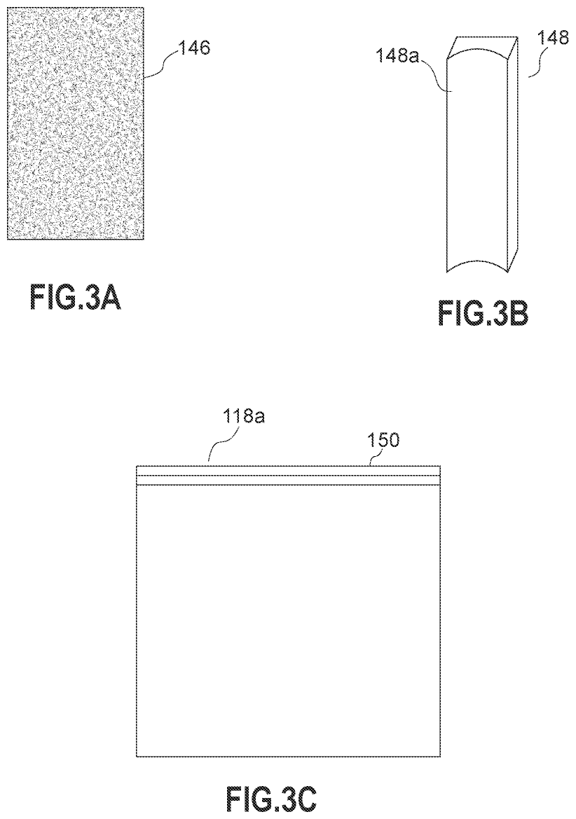

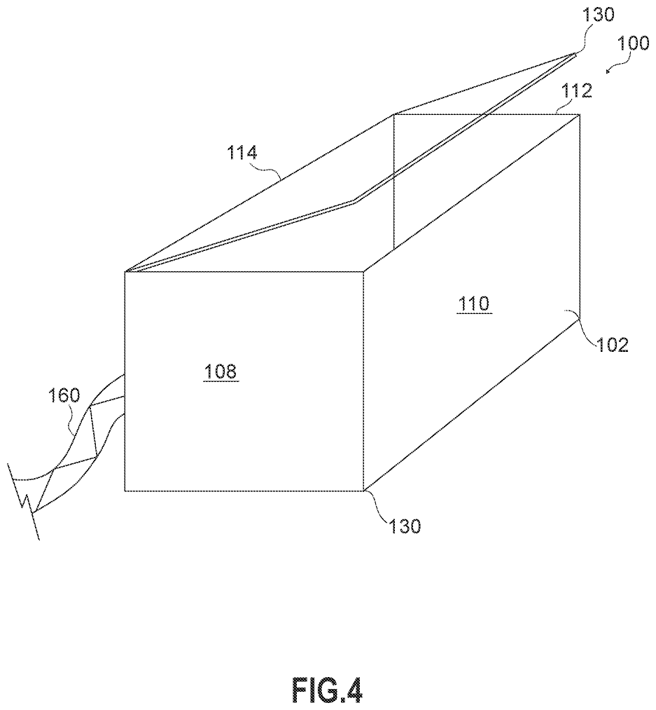

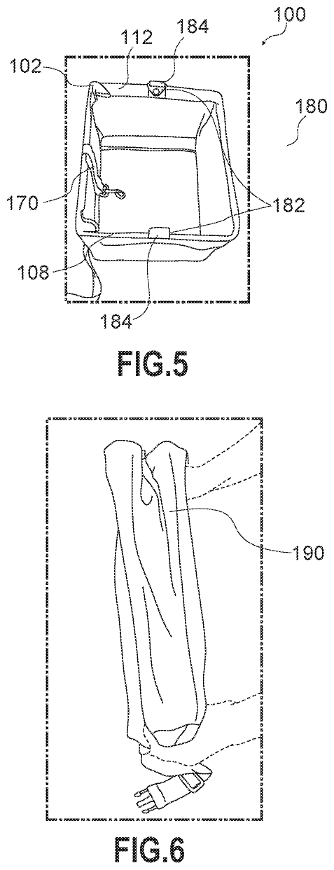

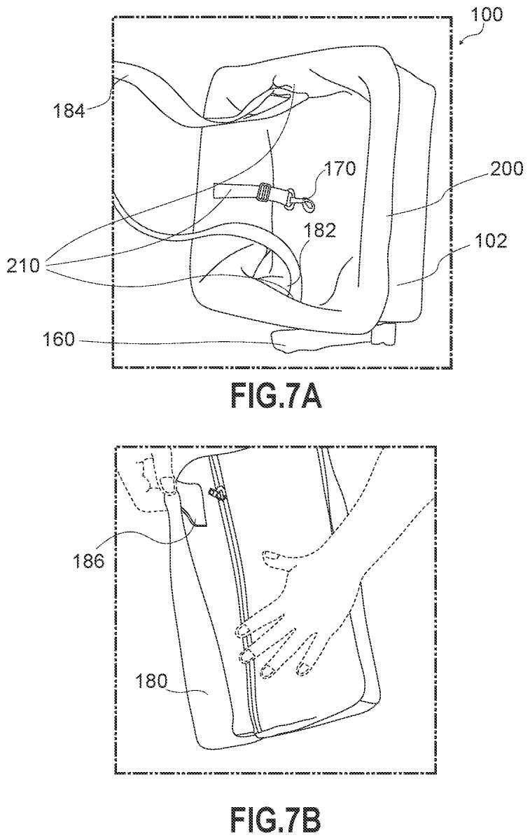

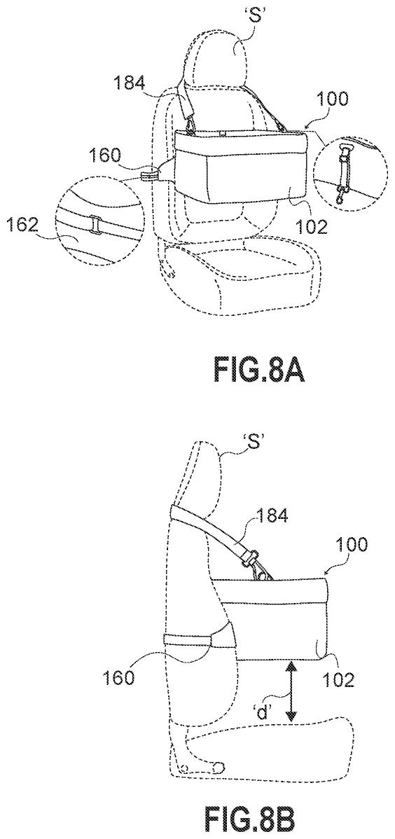

A pet safety bag 100 hereafter may also be referred to as “pet safety bag 100”, and will now be described in conjunction with FIGS. 1 to 8B, in accordance with an exemplary embodiment of the present disclosure. FIG. 1 illustrates an environment, whereby the pet safety bag 100 is shown to be placed along seat of the vehicle for carrying a pet. FIGS. 2A and 2B, respectively, illustrate a perspective and a side view of the pet safety bag 100. FIGS. 3A, 3B and 3C illustrate various coupling arrangements configured along the pet safety bag 100. FIG. 4 illustrates the pet safety bag 100 depicting one or more associated components thereof, and will be described herein. Further, FIG. 5 illustrates the pet safety bag 100 depicting various elements; FIG. 6 illustrates the pet safety bag 100 depicting a zipper arrangement; FIGS. 7A and 7B illustrate a pet safety bag 100 with a cushioning enclosure disposed within an extendable enclosure; FIG. 8A depicts a perspective view of the pet safety bag 100 coupled to the vehicle seat; and FIG. 8B depicts a side view of the pet safety bag 100 coupled to the vehicle seat.

As shown in FIGS. 1 to 3, the pet safety bag 100 includes an extendable enclosure 102 (may also be referred to as ‘enclosure 102’) and at least one supporting frame structure 130. The extendable enclosure 102 includes an inner space 104 defined by a bottom wall 106 and extendable side walls 108, 110, 112, 114 coupled to the bottom wall 106 along its edges and adapted to be extended upwardly from the bottom wall 106 to define bottom joint edge 116, and terminable at a top edge 118. The side walls 108, 110, 112, 114 are joined along respective edges thereof to define side joint edges 120. Further, the at least one supporting frame structure 130 is hingedably coupled along at least a portion of the top edge 118. The at least one supporting frame structure 130, at an engaging position, is configured to be coupled alongside of the side joint edges 120, and the bottom joint edges 116 to provide support to the extendable side walls 108, 110, 112, 114 to enable the extendable enclosure 102 to be in an extended position. Further, the at least one side supporting frame structure 130, at a non-engaging position, is configured to be uncoupled from the side joint edges 120, and the bottom joint edges 116 to collapse the extendable side walls 108, 110, 112, 114 to enable the extendable enclosure 102 to be in a collapsed position. The pet safety bag 100 in the extended position provides support to the extendable enclosure 102 and prevent deformation when a pet ‘P’ lay along the top edge 120 of the extendable enclosure 102 while travelling in a vehicle ‘V’, as specifically shown in FIG. 1.

In one embodiment, the bag 100 along the top edge 118 may include a frame to provide rigidity to the top edge 118 of the bag. Such frame is encapsulated along the top edge by the folding the fabric of the bag 100.

In one embodiment of the present disclosure, as seen in FIGS. 2A and 2B, the supporting frame structure 130 may include an upper frame member 132, side frame members 134 and a bottom frame member 136 joint together. The upper frame member 132 is releasably or hingedly coupled along at least one top portion 118a of the top edge 118. Further, the side frame members 134 are releasably coupled along at least two side joint edges 120a, 120b. Furthermore, the bottom frame member 136 is releasably coupled along at least one bottom joint edge 116a of the bottom joint edge 116.

In one embodiment of the present disclosure, as seen in front view of the pet safety bag 100 in FIG. 2B and described in conjunction to FIGS. 1 and 2A, the pet safety bag 100 further include a top releasably or hingedly coupling arrangement 140, side releasably coupling arrangements 142, and a bottom releasably coupling arrangement 144. The top releasably or hingedly coupling arrangement 140 is coupled along the at least one top portion 118a of the top edge 118 to couple the upper frame member 132. Further, the side releasably coupling arrangements 142 are coupled along the at least two side joint edges 120a, 120b to couple the side frame members 134. Moreover, the bottom releasably coupling arrangement 144 is coupled along the at least one bottom joint edge 116a of the bottom joint edge 116 to couple the bottom frame member 136.

Further, FIGS. 2C and 2D illustrate top perspective views of the pet safety bag 100 depicting the top releasably or hingedly coupling arrangement 140 coupled along the at least one top portion 118a of the top edge 118 by encapsulating the top portion 118a by foldable side of the bag 100 to form a channel to releasably or hingedly couple the upper frame member 132. Further, the side releasably coupling arrangements 142, such as a Velcro arrangement, are coupled along the at least two side joint edges 120a, 120b, as seen in FIG. 2D, to couple the side frame members 134. Moreover, the bottom releasably coupling arrangement 144, such as a Velcro arrangement, is coupled along the at least one bottom joint edge 116a of the bottom joint edge 116 to couple the bottom frame member 136. As shown in FIG. 2C, and described in conjunction with FIG. 1-2B, the bottom releasably coupling arrangement 144 may include a flap 144a having a Velcro 144b, such flap 144a may be opened from a complementary Velcro 144b coupled on the bottom wall 106 to receive the bottom frame member 136 along the at least one bottom joint edge 116a to secure the bottom frame member 136 between the flap 144a and the bottom wall 106 via the Velcro 144b and the complementary Velcro 144b.

Similar arrangement could also be along side portions for coupling the side frame members 134 along the side joint edges 120a, 120b. As seen in FIG. 2D, the side releasably coupling arrangements 142 may be a Velcro arrangement for coupling the side frame members 134 along the side joint edges 120a, 120b.

In one embodiment of the present disclosure, as also seen in FIG. 3A, the top releasably or hingedly coupling arrangement 140, the side releasably coupling arrangements 142, and the bottom releasably coupling arrangement 144 may be Velcro attachments 146.

In one embodiment of the present disclosure, as seen in FIG. 3B, the top releasably or hingedly coupling arrangement 140, the side releasably coupling arrangements 142, and the bottom releasably coupling arrangement 144 may be snap arrangements 148 having brackets 148a to releasably receive the upper frame member 132, the side frame members 134 and the bottom frame member 136.

In one embodiment of the present disclosure, as seen in FIG. 3C, the top releasably or hingedly coupling arrangement 140 may be a narrow channel 150 formed along the at least one top portion 118a of the top edge 118 to hingedly receive the upper frame member 132. In this embodiment, the supporting frame structure 130 from the upper frame member 132 may be inserted in the narrow channel 150 to permanently couple the supporting frame structure 130 with the pet safety bag 100, while the side frame members 134 and the bottom frame member 136 are detachably coupled to the joint edges 120a, 120b and the bottom joint edge 116 via the Velcro attachments 146 or the snap arrangements 148. The upper frame member 132 may pivot along the narrow channel 150 to obtain hinged coupling therebetween.

In one embodiment of the present disclosure, a shape of the supporting frame structure 130 corresponds to a shape of the side walls 108, 110, 112, 114 of the extendable enclosure 102. For example, as shown in FIGS. 2A and 2B, the shape of the side walls 108, 110, 112, 114 of the extendable enclosure 102 are square or rectangle, therefore, the shape of the supporting frame structure 130 is also square or rectangle. However, without departing from the scope of the present disclosure, if the shape of the side walls 108, 110, 112, 114 of the extendable enclosure 102 are circular or oval, the shape of the supporting frame structure 130 will correspond accordingly to circular or oval.

In one embodiment of the present disclosure, as shown in FIG. 4, the pet safety bag 100 may include the at least one supporting frame structure 130 coupled to the extendable enclosure 102 along other sides, such as longer side walls, apart from the side walls, such as shorter side walls, to expend and collapse the extendable enclosure 102, respectively, in the engaging position and the non-engaging position.

In one embodiment of the present disclosure the supporting frame structure 130 is a one-piece structure made of metal, alloy or hard plastic, and further may include protective covering for protection from rust and moisture if the supporting frame structure 130 is of metal.

In one embodiment of the present disclosure, as shown in FIG. 4, the pet safety bag 100 may include a securing arrangement 160 coupled to an outer surface 102a of the extendable enclosure 102. The securing arrangements 160 are adapted to be coupled to the vehicle seat ‘S’ for coupling the pet safety bag 100 to the vehicle seat ‘S’ of the vehicle ‘V’, as shown in FIG. 1. The securing arrangement 160 may be belt or any other arrangement that may safely secure the pet safety bag 100 with the seat.

In one embodiment of the present disclosure, as shown in FIG. 5, the pet safety bag 100 may further include a pet leashing member 170 coupled to the extendable enclosure 102. The pet leashing member 170 may be adapted to leash the pet when the pet is in the extendable enclosure 102.

In one embodiment of the present disclosure, as further shown in FIG. 5, the pet safety bag 100 may further include a carrying attachment 180 having a pair of engaging members 182 and a carrying strap 184. The pair of engaging members 182 may be coupled to opposite side wall 108, 112 of the extendable enclosure 102. Further, the carrying strap 184 may be removably coupled to the pair of engaging members 182 to carry the pet safety bag 100.

In one embodiment of the present disclosure, as shown in FIG. 6, the pet safety bag 100 may further include a zipper arrangement 190 coupled along an outer surface of the extendable enclosure 102. The zipper arrangement 190 in an open state enables expansion of the sides 108, 110, 112, 114 of the extendable enclosure, and in a closed state stores the sides 108, 110, 112, 114 of the extendable enclosure.

In one embodiment of the present disclosure, as shown in FIGS. 7A and 7B, the pet safety bag 100 may further include a cushioning enclosure 200 adapted to be disposed within the extendable enclosure 102 to provide comfort to the pet adapted to be kept in the extendable enclosure 102. The cushioning enclosure 200 generally complements a size of the extendable enclosure 102, and comprises one or more recesses 210. Such recesses 210 may be used to incorporate pet leashing member 170 and the pair of engaging members 182 to secure the cushioning enclosure 200 in the enclosure 102 of the pet safety bag 100. In one embodiment, as specifically shown in FIG. 7B, the cushioning enclosure 200 may also be additionally secured along an outer surface side of the extendable enclosure 102 via a securing member 186, such as Velcro, that is provided on the cushioning enclosure 200 and the extendable enclosure 102.

Referring now to FIGS. 8A and 8B, the pet safety bag 100 is shown to be coupled to the vehicle seat ‘S’. FIG. 8A depicts a perspective view and FIG. 8B depicts a side view of the pet safety bag 100 coupled to the vehicle seat ‘S’. To couple the pet safety bag 100 to the vehicle seat ‘S’, the securing arrangement 160, as shown in FIG. 4, and the carrying strap 184, as shown in FIG. 5, are utilized. As shown, the carrying strap 184 is attached around a neck portion of the vehicle seat ‘S’. The length of the carrying strap 184 is adjusted such that the extendable enclosure 102 of the pet safety bag 100 is at an elevated distance ‘d’ from a seat and aligned to the window of the vehicle so that the pet kept in the extendable enclosure 102 may view outside of the window of the vehicle. If not coupled to the neck of the vehicle seat ‘S’, the carrying strap 184 may be used for its usual purpose to carry a pet kept in the pet safety bag 100. Further, the securing arrangement 160 that may be a strap having an engaging buckle 162 to couple the pet safety bag 100 to a lower portion of the vehicle seat ‘S’ in such a manner that the strap surrounds the back of the vehicle seat ‘S’. The securing arrangement 160 and the carrying strap 184 together secure the pet safety bag 100 to the vehicle seat ‘S’ such that the pet safety bag 100 is non-movingly coupled to the vehicle seat ‘S’. Due to such arrangement, when a pet is kept in the pet safety bag 100, the pet is safe and still can enjoy looking outside of the window of the vehicle. Further, when the pet's leg is on the extendable enclosure 102 while enjoying looking outside of the window, the supporting frame structure 130 rigidly supports the pet safety bag 100 (the extendable enclosure 102) thereby preventing thereto from deformation.

The present disclosure is advantageous in overcoming the shortcomings of the conventional pet-containers. For example, the pet safety bag includes protection against deformation so that the pet safety is not compromised. For doing so, the supporting frame structure 130 may be disposed along one side of the pet safety bag 100 that provides support to that particular side of the pet safety bag 100, which in turn protects from being deformed when the pet take support on that side of the pet safety bag 100 and looking out of window, as seen in FIG. 1. In an alternative arrangement, such supporting frame structure 130 may also be used as to carry the pet safety bag 100 by a user, when the pet safety bag 100 is not used by the pet. Further, the pet safety bag is simple and easy to use deformation protection structure.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

What is claimed is:

1. A pet safety bag for carrying a pet in a vehicle, the pet safety bag comprising:
an extendable enclosure having an inner space defined by a bottom wall, and extendable side walls coupled to the bottom wall, each side wall of the side walls extends upwardly from the bottom wall and has a bottom edge coupled to the bottom wall to define a bottom joint edge, and each side wall of the side walls terminable at a top edge, wherein the side walls are joined along respective side edges thereof to define side joint edges;
at least one supporting frame structure the at least one supporting frame structure having an upper frame member, side frame members and a bottom frame member, wherein the upper frame member is hingedably coupled along at least a portion of the top edge;
a top hingedly coupling arrangement along at least one top portion of the top edge to couple the upper frame member, wherein the top hingedly coupling arrangement is a narrow channel formed along the at least one top portion of the top edge to hingedly receive the upper frame member;
a bottom releasably coupling arrangement coupled along at least one bottom joint edge of the bottom joint edges to couple the bottom frame member,
a carrying attachment having a pair of engaging members coupled to opposite side walls of the extendable enclosure along the at least one top portion of the top edge over the narrow channel, wherein the narrow channel has a top, and an inside, and the inside is facing the inner space, and an engaging member of the pair of engaging members overlaps the narrow channel by going over the inside and over the top of the narrow channel, and
wherein the upper frame member is inserted in the narrow channel to hingedly couple the supporting frame structure, while the bottom frame member is detachably coupled to the bottom joint edge,
wherein the at least one supporting frame structure, at an engaging position, configured to be coupled along the side joint edges, and the bottom joint edges to provide support to the extendable side walls to enable the extendable enclosure to be in an extended position, and
wherein the at least one supporting frame structure, at a non-engaging position, configured to be uncoupled from the side joint edges, and the bottom joint edges, while permanently retaining the upper frame member in the narrow channel that is overlapped by the pair of engaging members, to collapse the extendable side walls to enable the extendable enclosure to be in a collapsed position.

2. The pet safety bag of claim 1, wherein:
the side frame members are releasably coupled along at least two side joint edges.

3. The pet safety bag of claim 2 further comprising:
side releasably coupling arrangements along the at least two side joint edges to couple the side frame members.

4. The pet safety bag of claim 3, wherein:
the side releasably coupling arrangements, and the bottom releasably coupling arrangement are Velcro attachments.

5. The pet safety bag of claim 3, wherein:
the side releasably coupling arrangements, and the bottom releasably coupling arrangement are snap arrangements having brackets to releasably receive the side frame members and the bottom frame member.

6. (canceled)

7. The pet safety bag of claim 1, wherein:
the supporting frame structure comprises a shape that corresponds to a shape of one of the side walls of the extendable enclosure.

8. The pet safety bag of claim 1, wherein:
the supporting frame structure is a one-piece structure.

9. The pet safety bag of claim 1, wherein:
the supporting frame structure is of metals or alloy or hard plastics.

10. The pet safety bag of claim 1 further comprising:
securing arrangements coupled to the extendable enclosure, wherein the securing arrangements are adapted to be coupled to a vehicle seat for coupling the pet safety bag to the seat of the vehicle.

11. The pet safety bag of claim 1 further comprising:
a pet leashing member coupled to the extendable enclosure, the pet leashing member adapted to leash the pet when the pet is in the extendable enclosure.

12. The pet safety bag of claim 1 wherein:
the carrying attachment comprises:
a carrying strap removably coupled to the pair of engaging members to carry the pet safety bag.

13. The pet safety bag of claim 1 further comprising:
a zipper arrangement coupled along an outer surface of the extendable enclosure, wherein the zipper arrangement in an open state enables expansion of sides of the extendable enclosure, and in a closed state stores the sides of the extendable enclosure.

14. The pet safety bag of claim 1 further comprising:
a cushioning enclosure adapted to be disposed within the extendable enclosure to provide comfort to the pet adapted to be kept in the extendable enclosure,
wherein the cushioning enclosure complements a size of the extendable enclosure, and comprises a plurality of recesses.

15. A pet safety bag for carrying a pet in a vehicle, the pet safety bag comprising:
an extendable enclosure having an inner space defined by a bottom wall, and extendable side walls coupled to the bottom wall, each side wall of the side walls extends upwardly from the bottom wall and has a bottom edge coupled to the bottom wall to define a bottom joint edge, and each side wall of the side walls terminable at a top edge, wherein the side walls are joined along respective side edges thereof to define side joint edges;
at least one supporting frame structure, the supporting frame structure having an upper frame member, side frame members and a bottom frame member, wherein the upper frame member is hingedably coupled along at least a portion of the top edge;
a top hingedly coupling arrangement along at least one top portion of the top edge to couple the upper frame member, wherein the top hingedly coupling arrangement is a narrow channel formed along the at least one top portion of the top edge to hingedly receive the upper frame member;
a bottom releasably coupling arrangement coupled along at least one bottom joint edge of the bottom joint edges to couple the bottom frame member;
a carrying attachment having a pair of engaging members coupled to opposite side walls of the extendable enclosure along the at least one top portion of the top edge and wherein the narrow channel has a top, an inside, and an outside, wherein the inside is facing the inner space and the outside facing the opposite direction, and an engaging member of the pair of engaging members goes over the narrow channel, such that the engaging member overlaps the narrow channel by going over the inside and over the top of the narrow channel;
wherein the supporting frame structure from the upper frame member is inserted in the narrow channel to hingedly couple the supporting frame structure with the pet safety bag, while the bottom frame member is detachably coupled to the bottom joint edge,
wherein the at least one supporting frame structure, at an engaging position, configured to be coupled along the side joint edges, and the bottom joint edges to provide support to the extendable side walls to enable the extendable enclosure to be in an extended position, and wherein the at least one supporting frame structure, at a non-engaging position, configured to be uncoupled from the side joint edges, and the bottom joint edges, while permanently retaining the upper frame member in the narrow channel that is overlapped by the pair of engaging members, to collapse the extendable side walls to enable the extendable enclosure to be in a collapsed position; and
a cushioning enclosure adapted to be disposed within the extendable enclosure to provide comfort to the pet adapted to be kept in the extendable enclosure, wherein the cushioning enclosure complements a size of the extendable enclosure, and comprises a plurality of recesses.

16. The pet safety bag of claim 15 further comprising:
a pet leashing member coupled to the extendable enclosure, the pet leashing member adapted extend from one of the recesses of the plurality of recesses of the cushioning enclosure to leash the pet when the pet is in the extendable enclosure.

17. The pet safety bag of claim 15 further comprising:
a carrying strap removably coupled to the pair of engaging members to carry the pet safety bag,
wherein the pair of engaging members adapted to extend from at least one recess of the plurality of recesses of the cushioning enclosure.

18. The pet safety bag of claim 10, wherein the securing arrangement further includes a strap with an engaging buckle to couple the pet safety bag to a lower portion of the vehicle seat that the strap surrounds the back of the vehicle seat.

19. The pet safety bag of claim 1, wherein
the extendable enclosure has a first side walls and a second side walls,
the safety bag is coupled to the extendable enclosure along the first side walls of the side walls to expand and collapse the extendable enclosure in the engaging position and the non-engaging position, and
the first side walls are longer than the second side walls.

20. A pet safety bag for carrying a pet in a vehicle, the pet safety bag comprising:
an extendable enclosure having an inner space defined by a bottom wall, and extendable side walls coupled to the bottom wall, each side wall of the side walls extends upwardly from the bottom wall and has a bottom edge coupled to the bottom wall to define a bottom joint edge, and each side wall of the side walls terminable at a top edge, wherein the side walls are joined along respective side edges thereof to define side joint edges;
at least one supporting frame structure the supporting frame structure having an upper frame member, side frame members and a bottom frame member, wherein
the upper frame member is hingedably coupled along at least a portion of the top edge,
the side frame members are releasably coupled along at least two side joint edges, and
side releasably coupling arrangements along the at least two side joint edges to couple the side frame members;
a top hingedly coupling arrangement along at least one top portion of the top edge to couple the upper frame member, wherein the top hingedly coupling arrangement is a narrow channel formed along the at least one top portion of the top edge to hingedly receive the upper frame member;
a bottom releasably coupling arrangement coupled along at least one bottom joint edge of the bottom joint edges to couple the bottom frame member,
a carrying attachment having a strap and a pair of engaging members, wherein an engaging member of the pair of engaging members is coupled along the at least one top portion of the top edge over the narrow channel, such that the engaging member of the pair of engaging members overlap the narrow channel, wherein the narrow channel has a top, an inside, and an outside, and the inside is facing the inner space and the outside is facing the opposite direction, and an engaging member of the pair of engaging members goes over the narrow channel such that the engaging member overlaps the inside, and the top of the narrow channel, and
wherein the upper frame member is inserted in the narrow channel to hingedly couple the supporting frame structure, while the bottom frame member is detachably coupled to the bottom joint edge,
wherein the at least one supporting frame structure, at an engaging position, configured to be coupled along the side joint edges, and the bottom joint edges to provide support to the extendable side walls to enable the extendable enclosure to be in an extended position, and
wherein the at least one supporting frame structure, at a non-engaging position, configured to be uncoupled from the side joint edges, and the bottom joint edges, while permanently retaining the upper frame member in the narrow channel that is overlapped by the pair of engaging members, to collapse the extendable side walls to enable the extendable enclosure to be in a collapsed position.

21. The pet safety bag for carrying a pet in a vehicle of claim 20 wherein the carrying attachment has the strap attached to the pair of engaging members and the engaging members are coupled to opposite side walls of the extendable enclosure.
